(19) United States
(12) Patent Application Publication
(10) Pub. No.: US 2009/0151533 A1
(43) Pub. Date: Jun. 18, 2009

(54) Slitting Machine

(76) Inventors: Wenzhao Lan, Mississauga (CA); Joseph Kwadjo Konney, Hamilton (CA); Steven Zayeri, Toronto (CA); Danko A. Dobes, Ancaster (CA); David H. Grunsky, Mississauga (CA); Ralph Michael Parsons, Toronto (CA); Vasile Radu Verdes, Etobicoke (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/267,409

(22) Filed: Nov. 7, 2008

Related U.S. Application Data
(60) Provisional application No. 60/986,892, filed on Nov. 9, 2007.

(51) Int. Cl. B26D 1/12

(52) U.S. Cl. 83/663

(57) ABSTRACT

A slitting machine is provided which is capable of automatically setting and moving the knife blades used in the cutting operation. The slitting machine includes a moveable gantry which is provided with attachment forks for engaging a knife holder, and knife holder locking and unlocking means for releasing the knife holder from an arbor. The system is adapted to by controlled by a PLC or some other computerized device, and enables faster adjustment of the knives of a slitting machine.

### RELATED APPLICATIONS

This application claims the benefit of priority under 35 U.S.C. § 119(e) to U.S. Provisional Application Ser. No. 60/986,892 filed on Nov. 9, 2007, the entirety of which is hereby incorporated by reference.

### FIELD OF THE INVENTION

The present invention relates to the field of slitter machines used for slitting metal strips into smaller “mults” or smaller strips, and in particular, to a slitting machine which includes an automated blade, or blade holder, positioning system.

### BACKGROUND OF THE INVENTION

Much of the metal produced by mills is in the form of coiled strips, but rarely does the original strip correspond in width to the multitude of products that are stamped or otherwise formed from it. Accordingly, the metal strip sheet is usually slit longitudinally to various sizes which are suitable for the particular products. Indeed, special slitting machines are made for this purpose.

The typical slitting machine, or “slitter”, has circular blades or knives arranged in pairs on two powered shafts or arbors, there being one of a mated pair of knives on each arbor. The arbors are connected to a drive system for counter-rotation. During operation, sheet metal is moved between the arbors and cut into strips, or “mults”, by the knives counter-rotating on the arbors. Actually each knife is nothing more than a hardened steel disk having flat end faces and a cylindrical peripheral face which intersects the end faces at relatively sharp cutting or shearing edges. The disks of each pair of knives are positioned on their respective arbors, often with a slight overlap. Overlap or not, the knives of each pair are positioned close enough to each other to enable them to cut or shear the metal sheet as it passes between those knives. In other words, the metal strip is drawn between the two knives of a pair, and the disk-like knives shear the strip along the opposite cutting edges, thus producing a clean longitudinal cut in the strip.

The size of the mults is determined by the spacing of the knives on the arbors, and as such, the knives can be moved on the arbor. However, after the knives have been located on the arbors, they must be fastened to, or otherwise connected to the arbor in such a fashion that they rotate with the arbor while the cutting process occurs. Slippage of a knife blade, held within a knife or blade holder, or slippage of the holder, is to be avoided since this can damage the knife, holder or arbor, and cause the blade to wobble, or cause the blade to cut incorrect mult widths.

The knives, while being fixed firmly on their respective arbors during the operation of the machine, nevertheless may be removed for sharpening, or may be repositioned so that the width of the mults may be varied. Setting the knives on the arbors of a slitting machine however is a tedious and time-consuming procedure, requiring a high degree of skill, for the knives must be located with considerable precision, not only to acquire the proper width for the cut, but to also maintain a clean high quality cut as well.

In one prior art approach to setting and holding the knives in position, the knives are positioned on a thin walled arbor and the outer surface of the arbor can be slightly expanded so as to increase the arbor's outer diameter. This will allow it to engage and hold the inside diameter of a closely fitted knife blade holder. However, this option requires a specialized arbor to be produced at significantly increased cost. Further, if a blade holder is over-tightened, or remains in place on the arbor for an extended period, it is possible to form recesses on the arbor in which the holder rests. It is then physically difficult to move the holder to other locations on the arbor, and damage of the arbor can occur as the holder is forced into a new position.

In another approach, the arbor is a solid arbor that maintains a constant diameter. In this approach, the knife holder has a inner surface which can be mechanically contracted by twisting of an adjustment bolt, or the like. Typically, this type of holder has a series of rib like projections on its inner surface which allow the inside diameter to be varied, and these rib like projections will be pressed inwards towards the arbor.

However, with these mechanical attachment means, the final locking adjustment can cause the knife blade to twist slightly as it is being tightened. This can lead to the knife blade not being perpendicular to the arbor and not being perpendicular to the travel direction of the strip to be cut. This causes wobble in the blade and again, can cause damage to the blade, the holder, the arbor and/or to the material being cut.

To avoid this incorrect alignment and/or position, the arbor can also be fitted with a variety of spacers or shims which are used to hold the blade in the proper position on the arbor, as well as hold the blade in the desired alignment. These spacers and shims are large enough and are machined with enough precision to minimize the wobble inherent with this approach, but can present complexities in the selection of spacers and shims to properly locate the knives. Moreover, selection of spacers and shims requires a considerable amount of skill, and positioning of the blades within a series of spacers is a time consuming operation. Further, a trained machinist is required in order to ensure that the holders, blades, spacers, shims and arbors are all correctly placed and positioned without incurring any damage to these devices, including nicks and scratches which might affect the balance and wobble of the spinning devices.

A more recent approach, however, has been to use a hydraulic blade holder in which a thin metal membrane on the inner surface of the blade holder is caused to expand so as to decrease the inner diameter of the blade holder, and thus, clamp onto the solid arbor. This is achieved by providing a thin metal membrane on the inner surface of the blade or knife holder, and expanding the membrane by increasing the hydraulic pressure within a hollow chamber located behind the membrane. Locking of the knife or blade holder is achieved by pressurizing the fluid contained within the chamber, to cause the membrane to flex outward, and thus, reduce the inner diameter of the knife holder. This causes the holder to clamp onto the circular, solid arbor.

Typically, the preferred fluid to be used is grease which has been injected into, and fills the chamber. The clamping force of the holder onto the arbor can be adjusted by adjusting the pressure within the chamber.

Typically, the chamber pressure is increased by attaching a specific grease gun, or the like, to a nipple located on the holder, and using the grease gun to increase the pressure within the chamber. Pressures of approximately 300 bar, or higher are used to lock the holder in place on the arbor. The pressure can be released by opening a socket set screw and ball assembly which allows some of the grease to be released from the chamber. However, this grease must be collected so as to avoid contamination of the metal strip, or arbor surface, or the like.

Again, however, this approach requires a skilled machinist to locate the blades and/or blade holders in a specific location, and requires the machinist to use a specific tool or tools to lock or release the holder from the arbor.

Various attempts have been made to automate or expedite blade replacement or positioning, including, for example, turret system wherein a variety of arbors are provided that can be relatively quickly moved into an operative position on the slitting machine, or systems where a knife holder can be moved to a “stop” on the arbor from a storage arbor, and then manually clamped into place. However, further improvements to these automated approaches would be desirable.

Accordingly, it would still be advantageous to provide a slitting machine which was adapted to provide more rapid and/or completely automated movement and re-positioning of knife or blade holders on the arbor. Thus, there remains a need in the art for slitting machines which can be automatically set up and adjusted, including the replacement or servicing of knives on the arbors, with minimal labor on the part of the operator or user.

### SUMMARY OF THE INVENTION

The present invention overcomes the foregoing and other shortcomings and drawbacks of slitting systems and methods of slitting heretofore known. While the invention will be described in connection with certain embodiments, it will be understood that the invention is not limited to these embodiments. On the contrary, the invention includes all alternatives, modifications and equivalents as may be included within the spirit and scope of the present invention.

The advantages set out hereinabove, as well as other objects and goals inherent thereto, are at least partially or fully provided by the slitting machine of the present invention, as set out herein below.

Accordingly, in one aspect, the present invention provides a slitting machine having a frame structure, upper and a lower rotating arbors mounted on said frame, and connected to at least one drive motor for counter-rotation of the arbors, at least one pair of knife holder assemblies provided on each arbor which each support and hold one of a pair of mated knife blades, and an automated knife holder positioning device fitted to said frame.

The knife holder positioning device is preferably a linearly moveable gantry, which moves in a linear fashion parallel to the arbors. Fitted to the gantry are extendable and retractable upper and lower knife holder temporary attachment means for temporary attachment to the knife blade or knife holder fitted on to the upper and lower arbor, and an extendable and retractable knife holder locking means for locking, or unlocking, the knife holder from either of said upper or lower arbors.

The upper and lower knife holder attachment means are preferably two-pronged, “fork” shaped devices which are adapted to fit within slots provided on the knife holder. As such, the prongs of the attachment means can be extended so as to be inserted into mated openings on the knife holder, and the gantry can then be moved in a linear fashion, parallel to the arbor, in order to move the knife holder along the arbor.

The extendable and retractable knife holder locking means is preferably an extendable screwdriver device which is fitted to the prongs of the fork shaped holder attachment means, and is adapted to connect with a pressure adjusting set screw provided on a hydraulic knife holder. As such, the screwdriver preferably travels with the holder attachment means, but can be mounted separately.

A preferred version of such a hydraulic knife holder is described in our co-pending U.S. patent application No. 60/986,886.

The position of the knife holder, or more importantly, the knife itself, can be measured and controlled so that the knife blade is correctly positioned. Movement of the gantry on the frame can be controlled by any of a number of devices, such as programmable logic controller (PLC) devices, or other computerized equipment. Movement of the gantry is preferably powered by a servo motor mounted on the frame, which is operatively connected by a linear screw, or more preferably, a ball screw, to the gantry.

As such, controlled movement of the servo motor effects controlled movement of the gantry along one or more rails which are provided for such purpose, on the frame.

The position of the gantry can be monitored in a variety of manners, but one preferred method is by use of a linear encoder which provides data on the exact position of the gantry.

In operation, the gantry is moved from a storage position, which is in a non-interfering position on the slitting machine, to a position where the knife holder (or knife) can be engaged.

The prongs of the fork-shaped knife holder attachment means are then extended so as to engage the mated attachment means on the knife holder.

Release of the knife holder from the arbor is achieved using the knife holder locking means, which can be extended from the gantry (preferably together with the holder attachment means), mated with the set screw, or other locking device on the knife holder, and operated so as to release the knife holder from the arbor. The knife holder locking means can then optionally be retracted.

Once the knife holder has been released from the arbor, the gantry is moved to a new position, and the knife holder is moved along with the gantry by sliding along the arbor. Once the gantry is correctly positioned in the new position, the knife holder locking means can again be extended (if needed) so as to engage the knife holder, and the knife holder locking means activated to lock the knife holder in place.

If necessary, the knife holder locking means, and the prongs of the knife holder attachment means can then be retracted, and the gantry returned to its storage position.

This operation can be repeated for the upper and lower knife holders which are positioned on the upper and lower arbors.

Preferably, the gantry holds two sets of separate knife holder attachment means, and knife holder locking means, located so as to be essentially vertically aligned or slightly offset from one another, and which are individually adapted to be mated to the knife holders on each of the upper and lower arbors. This can be done separately, or simultaneously.

The number of blade pairs is typically between 1 and 10, but any number of blade pairs can be utilized depending on the design of the slitting machine. Unused blade pairs, when not needed, can be moved to a storage area on the arbor by movement of the gantry, and returned to service as required.

Movement of other devices fitted to the arbor, such as spacers or the like, or stripper rings or plates, can also be effected using the device of the present invention.

In a further aspect, the present invention also provides a method of automatically positioning one or a plurality of knife blades on a slitting machine, in the manner described herein below.

### DETAILED DESCRIPTION OF THE INVENTION

In the present application, the term “slitting machine” or “slitter” refers to a device used to slit a strip of metal, such as steel, aluminum, or the like, into a plurality of smaller strips, or mults, of a desired width. However, the skilled artisan will be aware that slitters are used to slit other materials, such as paper, cardboard, or the like, and thus, the holder of the present invention, can be used in a wide variety of applications.

Accordingly, while the present application is hereinafter described with particular reference to the a knife holder which is used slit a metal strip into mults, the skilled artisan would be aware that the present application is equally applicable in a variety of other applications.

Further, unless otherwise specifically noted, all of the features described herein may be combined with any of the above aspects, in any combination.

### BRIEF DESCRIPTION OF THE DRAWINGS

Embodiments of this invention will now be described by way of example only in association with the accompanying drawings in which:

FIG. 1 is a perspective drawing of a slitting machine of the present invention;

FIG. 2 is an enlarged view of one section of the slitting machine of FIG. 1;

FIG. 3 is a second perspective drawing of the slitting machine shown in FIG. 1;

FIG. 4 is a perspective, exploded view of a preferred knife holder to be used in on the slitting machine of the present invention; and

FIG. 5 is a further perspective view of a portion of the slitting machine of FIG. 1 wherein one fork is extended and the other is in a retracted position.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

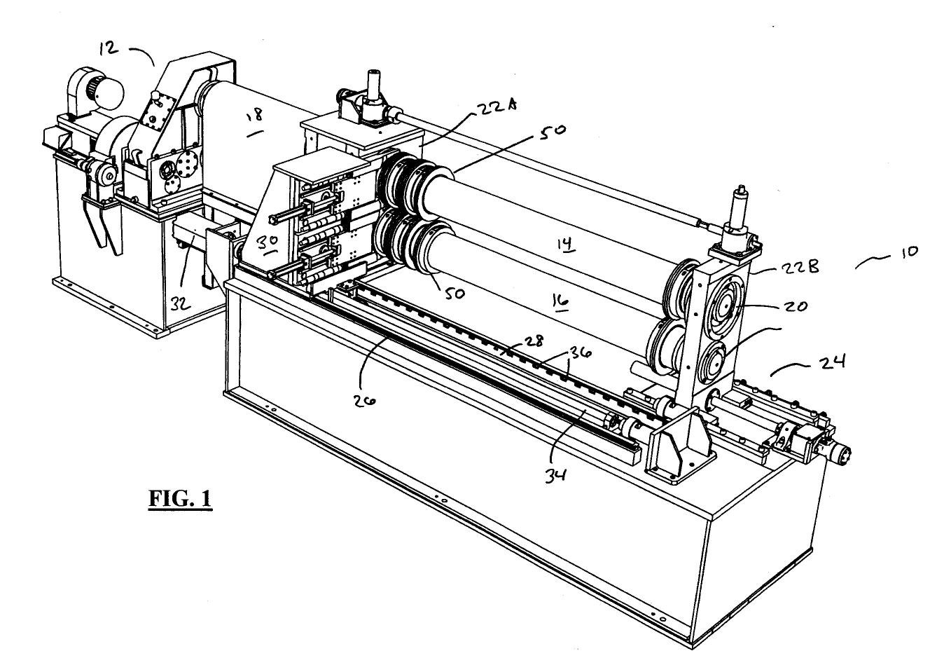

Referring to FIG. 1, a slitting machine 10, accordingly to the present invention, is shown which is adapted to slit a strip of a metal, such as a steel strip, into smaller strips of desired width(s). The metal strip to be cut is normally provided from a mill or other supplier of products in a coil (not shown). Material is fed from the coil and fed into slitting machine 10 between arbors 14 and 16. 18. The coiled material may be pre-treated, such as passing through a straightening machine in order to remove the coil set, in a manner known to the skilled artisan. The metal strip might also be fed into slitting machine 10 in individual sections, preferably with the assistance of a skewed roller table (not shown) or the like.

Slitting machine 10 is connected to a motor section 12. Motor section 12 can be any suitable motorized device known to those skilled in the art, and is connected to a pair of counter-rotating arbors, indicated as upper arbor 14 and lower arbor 16. Motor section 12 is operatively connected to arbors 14 and 16 using a gear box, or some other transmission assembly, and a pair of drive shafts (not seen) beneath drive shaft cover 18. Arbors 14 and 16 are supported by support bearings 20 located at each end of arbors 14 and 16. Support bearings 20 are located on arbor support stands 22A and 22B, which form part of the overall slitting machine frame, generally indicated as “24”.

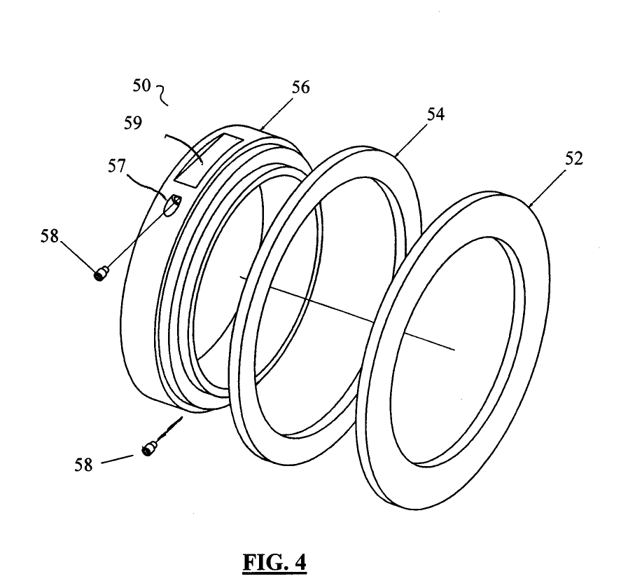

A series of mated knives 50 are shown on arbors 14 and 16, and each includes a blade 52, stripper ring 54, and knife holder 56. Details of the construction of a most preferred type of knife holder, is shown in FIG. 4, and includes a hydraulic knife holder assembly, which is locked or unlocked from arbors 14 and 16 by rotation of set screws 58 positioned within a counterbored opening 57 that provides access to a hydraulic membrane used to tighten the blade holder onto a solid arbor. Further details of the construction of knives 50 is described in our co-pending U.S. application No. 60/986,886, the contents of which are incorporated herein by reference.

Knives 50 are capable of being slid along arbors 14 and 16, when in there unlocked position. Knives 50 also include a slot 59, on opposite sides of holder 56, which can be used to move the knives, in the manner described hereinbelow.

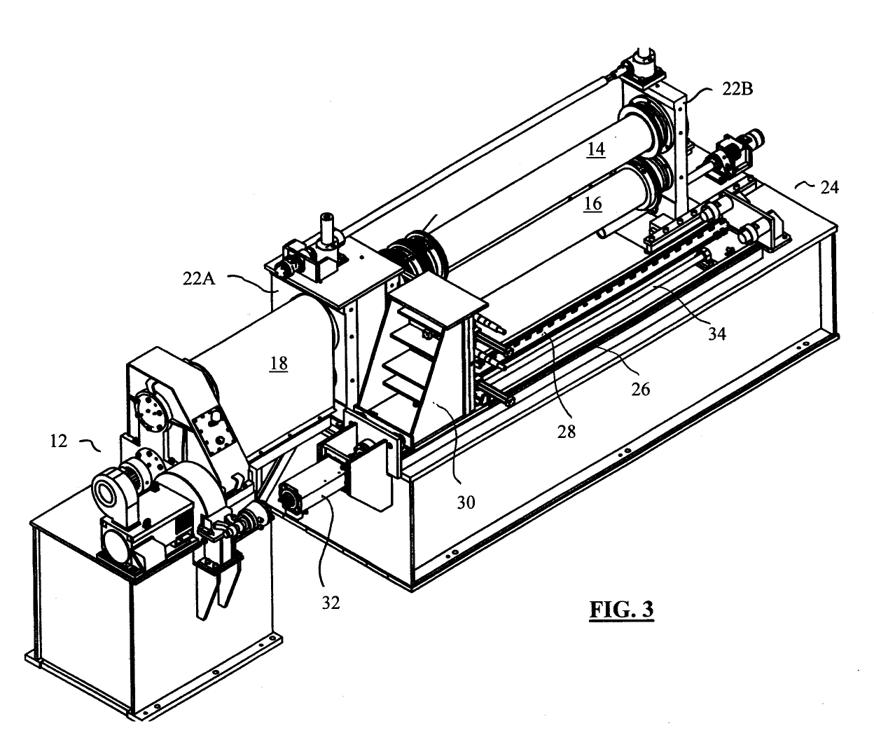

As seen in FIGS. 1 to 3, a gantry 30 is provided at one end of slitting machine 10 which is capable of linear movement parallel to arbors 14 and 16, by sliding along rails 26 and 28. Gantry 30 is moved back and forth by a servo motor 32 (seen in FIG. 3) which is operatively connected to a ball screw 34. A linear screw drive might also be used, but the use of a ball screw is preferred for improved control of the movement of gantry 30.

The exact position of the gantry is determined by a linear encoder 36 incorporated as part of rail 28. In this fashion, the gantry can be moved to a specific location, and accurately measured and confirmed to be in the desired position.

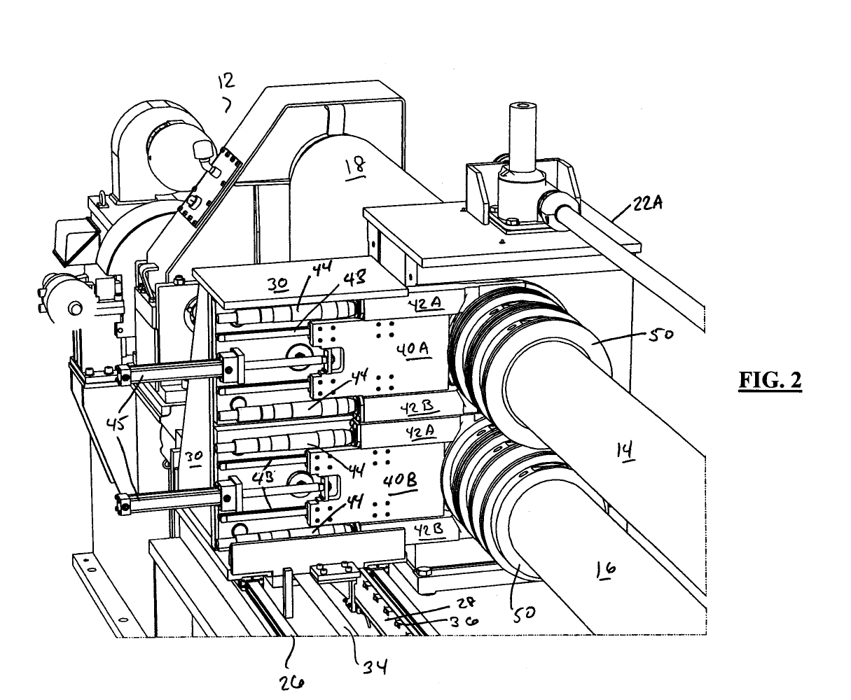

Mounted on gantry 30, are upper and lower knife holder attachment forks (40A and 40B) which each are “fork”-shaped and have upper and lower “prongs” (42A and 42B). Attachment forks 40 can be extended or retracted by movement along rails 43, using electrically powered and controlled actuators 45. In operation, knife holders 50 are turned so as to be in position so that when prongs 42 of fork 40 contact knife holder 50, they are fitted within slots 59 on the holder 50, and thus form a positive contact with the knife holders 50. Upper and lower electrically operated “screwdrivers” (44A and 44B) are fitted within prongs 42 of knife holder attachment forks 40. As such, in operation, as prongs 42 are extended so as to engage slots 59 in holder 50, as seen in FIG. 2 wherein both forks 40A and 40B are extended, the preferably hexagon shaped, spring-loaded driver of screwdrivers 44, is inserted into counterbored openings 57, and makes contact with set screws 58. Simultaneously with the placement of forks 40 within slots 59, screwdrivers 44 engage the set screws 58. Screwdrivers 44 can then be activated to turn screws 58 so as to release the hydraulic pressure within knife holder 50. Once this pressure has been released, knife holder 50 is free to move.

Thus, gantry 30 can be moved by servo motor 32 to a new position, and knife holder 50 follows the movement of gantry 30 by sliding along arbors 14 or 16.

Once the knife holder 50 is in its new position, screwdrivers 44 are operated to as to tightened set screws 58 in order to increase the pressure within the hydraulic knife holders 50, and thus lock knife holder 50 in place.

After the knife holder 50 is locked in its new position, fork 40, and thus prongs 42 and screwdrivers 44, are retracted so as to be disengaged from holder 50. Gantry 30 can then be moved to its next operative position, or moved to a storage location at or near one or the other end of the arbors.

Further, while forks 40A and 40B are shown as being located one on top of another, typically (and preferably) only one knife holder is moved at any given time. As such, the knife holders 50 located on the upper and lower arbors 14 and 16 are moved separately. In this manner, the gap and overlap of the knife blades 52 can be adjusted and controlled.

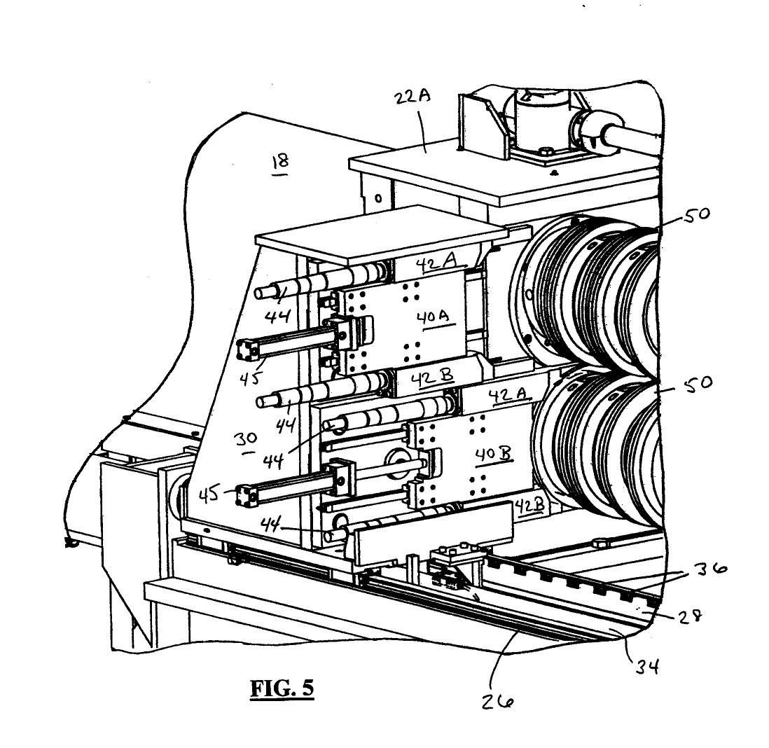

This option is seen in FIG. 5 wherein one fork 40A is extended, and the other fork 40B remains in the retracted position. Alternatively, however, forks 40A and 40B could be coupled together so that the upper and lower forks (40A and 40B) can simultaneously move knife holders 50 on both arbors 14 and 16. Normally, however, this is not practical unless the forks are arranged so as to provide some control of the gap and overlap of blades 52.

Typically, as in the prior art, an arbor is fitted with between 1 and 10 pairs of knives, and more preferably, between 2 and 6 pairs of knives. As such, a presently preferred slitting machine will cut from one-to-five mults from the original metal strip material.

When not in use, the un-needed excess knives can be moved to one side of the arbor, or the other, and locked into a storage position where they do not interfere with the metal strip passing through the slitting machine.

Similarly, when gantry 30 is not required, it is moved to a storage position where it also does not interfere with the metal strip passing through the slitting machine.

The movement of gantry 30, and operation of the forks 40 and screwdrivers 44, can all be controlled by a programmable logic controller (PLC), or some other computerized device (not shown), which is connected to a human interface device, such as a keyboard, or touch screen device. In this computerized environment, the operator selects the number of desired mults, the desired individual mult widths, the material thickness, and other parameters, and then allows the gantry of the slitting machine to automatically operate and unlock the knives currently in use (if necessary), move the knives to the desired positions, add additional knives and/or store any un-needed knives, and then lock the knives into position. As such, the slitting machine itself sets up the knife locations automatically.

The “screwdrivers” 44 are one convenient method to lock and un-lock knife holders 50. However, other means might also be used, including for example, a hydraulic connection that would connect directly to the hydraulic system of the knife holder.

The “forks” 40 and “prongs” 42 can also be replaced by various other shapes and designs, and the method of contact with knife holders 50 can be modified. For example, a series of pins could be extended from forks 40 so as to engage openings in knife holder 50 instead of using slots 59.

The linear encoder 36 is a preferred option for determining the position of the gantry. However, other optical or electrical methods for determination of the position of gantry 30, and ultimately, the position of knife blades 52, could also be used.

The embodiment shown herein is particularly useful for a solid arbor design. However, in an alternative embodiment, the arbor could be a thin-walled arbor, and the gantry used simply to move the knife holders to a new position. The membrane on the arbor would then be used to lock or un-lock the knife holders on the arbor.

Thus, it is apparent that there has been provided, in accordance with the present invention, a slitting machine which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A slitting machine comprising a frame structure, upper and a lower rotating arbors mounted on said frame, and which are connected to at least one drive motor for counter-rotation of the arbors, at least one pair of knife holder assemblies provided on each arbor which each support and hold one of a pair of mated knife blades, and an automated knife holder positioning device fitted to said frame,
wherein said knife holder positioning device is preferably a linearly moveable gantry, which moves in a linear fashion parallel to the arbors, and fitted to the gantry are extendable and retractable upper and lower knife holder temporary attachment means for temporary attachment to the knife blade or knife holder fitted on to the upper and lower arbor, and an extendable and retractable knife holder locking means for locking, or unlocking, the knife holder from either of said upper or lower arbors.

2. A slitting machine as claimed in claim 1 wherein said upper and lower knife holder attachment means are preferably two-pronged, “fork” shaped devices which are adapted to fit within slots provided on the knife holder.

3. A slitting machine as claimed in claim 2 wherein said prongs of the attachment means can be extended so as to be inserted into mated openings on the knife holder so that movement of said gantry in a linear fashion, parallel to the arbor, moves said knife holder along the arbor.

4. A slitting machine as claimed in claim 1 wherein said extendable and retractable knife holder locking means is an extendable screwdriver device which is fitted to said knife holder attachment means, and is adapted to connect with a pressure adjusting set screw provided on a hydraulic knife holder.

5. A slitting machine as claimed in claim 1 wherein movement of the gantry on the frame is controlled by a programmable logic controller (PLC) device, or by other computerized equipment.

6. A slitting machine as claimed in claim 1 wherein movement of the gantry is powered by a servo motor mounted on the frame, which is operatively connected by a linear screw, or more preferably, a ball screw, to the gantry.

7. A slitting machine as claimed in claim 6 wherein controlled movement of the servo motor effects controlled movement of the gantry along one or more rails which are provided for such purpose, on the frame.

8. A slitting machine as claimed in claim 7 wherein position of the gantry is monitored by use of a linear encoder which provides data on the exact position of the gantry.

9. A slitting machine as claimed in claim 1 wherein said gantry can be stored in a storage position where it does not interfere with material passing through said arbors.

10. A slitting machine as claimed in claim 1 wherein said gantry holds two separate knife holder attachment means and knife holder locking means, located so as to be essentially vertically aligned, and which are adapted to be mated to the knife holders on the upper and lower arbors.

11. A slitting machine as claimed in claim 1 wherein the number of blade pairs is between 1 and 10.

12. A slitting machine as claimed in claim 11 wherein the number of blade pairs is between 2 and 6.

13. A slitting machine as claimed in claim 1 wherein un-needed knife holders can be moved to a storage area on the arbor by movement of the gantry, and returned to service by movement of the gantry, as required.

14. A method of automatically positioning one or a plurality of knife blades on arbors of a slitting machine, in the manner described herein above, by use of a slitting machine as claimed in claim 1.
